(19) United States
(12) Patent Application Publication
(10) Pub. No.: US 2015/0192536 A1
(43) Pub. Date: Jul. 9, 2015

(54) Biosensor Using Capacitance and Sample Inflow Sensing Method Based on Capacity

(71) Applicant: Center for Integrated Smart Sensors Foundation, Daejeon (KR)

(72) Inventors: Ki Sung Son, Chungcheongbuk-do (KR); Chong Min Kyung, Daejeon (KR); Min Su Kwon, Gyeonggi-do (KR); Jong Ho Park, Daejeon (KR)

(73) Assignee: Center for Integrated Smart Sensors Foundation, Daejeon (KR)

(21) Appl. No.: 14/322,836

(22) Filed: Jul. 2, 2014

(30) Foreign Application Priority Data
Jan. 6, 2014 (KR) 10-2014-0001191

(51) Int. Cl. G01N 27/327

(52) U.S. Cl. CPC G01N 27/327

(57) ABSTRACT

A biosensor and a sample inflow sensing method are disclosed. The biosensor includes a sample sensing electrode configured to sense inflow of a sample; a component measuring electrode configured to measure a specific component contained in the sample; and an integrated circuit unit for controlling configured to apply a power to the sample sensing electrode periodically and to determine the inflow of the sample based on a capacitance generated by the power applied to the sample sensing electrode.

### CROSS REFERENCE TO RELATED APPLICATION

This application claims priority from and the benefit of Korean Patent Application No. 10-2014-0001191, filed on Jan. 6, 2014, which is hereby incorporated by reference for all purposes as if fully set forth herein.

### BACKGROUND OF THE DISCLOSURE

1. Field of the Disclosure

Exemplary embodiments of the disclosure relate to a biosensor using a capacitance and a sample inflow sensing method based on the capacitance, more particularly, to technology for a biosensor sensing inflow of a sample.

2. Discussion of the Background

Our contemporaries have such various adult diseases as diabetes, hyperlipidemia and anemia. It is simple and effective to measure components in blood as a method for determining whether people have such adult diseases.

Especially, it may provide even normal people not experts such as doctors with useful information to measure components in blood, using a blood composition measuring instrument.

Cited reference 1 (Korean Patent Gazette No. KR 10-1003077 B1 filed on 2010, Jan. 21) discloses a biosensor.

FIG. 1 illustrates a biosensor shown in FIG. 1 disclosed in the cited reference 1. the biosensor 1 includes a lower plate 5 having a working electrode 2, a reference electrode 3 and a bio-sensing electrode 4 formed thereon; an intermediate plate 7 disposed on the lower plate, with a sample inserting passage 6 formed therein; and an upper plate 8 disposed on the intermediate plate 7. A connection terminal 9 for the working electrode 2, the reference electrode 3 and the bio-sensing electrode 4 is inserted in an external device (in other words, a measuring instrument).

As shown in FIG. 2, the biosensor 1 may be inserted in the measuring instrument and the data measured by the biosensor 1 (e.g., a measured level for a specific component in blood) is output to the measuring instrument.

### SUMMARY OF THE DISCLOSURE

Exemplary embodiments of the present disclosure provide a biosensor for sensing a sample inflow based on a capacitance and a method for sensing sample inflow.

Additional features of the present disclosure will be set forth in the description which follows, and in part will be apparent from the description, or may be learned by practice of the disclosed subject matter.

Exemplary embodiments of the present disclosure disclose a biosensor including a sample sensing electrode configured to sense inflow of a sample; a component measuring electrode configured to measure a specific component contained in the sample; and an integrated circuit unit for controlling configured to apply a power to the sample sensing electrode periodically and to determine the inflow of the sample based on a capacitance generated by the power applied to the sample sensing electrode.

The integrated circuit unit for controlling may measure capacitances generated by the power applied to the sample sensing electrode and determine that the sample flows in, when the measured capacitance is over a preset level or change in the capacitances is beyond a preset range.

The integrated circuit unit for controlling may convert a dormant state applying the power only to the sample sensing electrode, not to the component measuring electrode, into an activated state applying the power to the component measuring electrode once determining that the sample flows in.

The integrated circuit unit for controlling may measure a specific component contained in the sample based on electric change of the component measuring electrode generated by the reaction between an enzyme immobilized on the component measuring electrode and the sample.

Exemplary embodiments of the present disclosure also disclose a biosensor including a first plate; a sample sensing electrode formed on the first plate to sense inflow of a sample; a component measuring electrode formed on the first plate to measure a specific component contained in the sample; a second plate disposed on the first plate where the sample sensing electrode and the component measuring electrode are formed; and a third plate disposed on the second plate, wherein a sample inlet is formed in the second plate to guide the flowing sample along a structure configured for the flowing sample to reach the component measuring electrode, not the sample sensing electrode.

The sample sensing electrode may be arranged adjacent to the component measuring electrode, spaced apart a predetermined distance in a direction in which the sample is flowing in.

The sample sensing electrode may be arranged adjacent to the component measuring electrode, spaced apart a predetermined distance in a direction in which the sample is flowing in, and the second plate may include a first intermediate plate disposed on the first plate on which the sample sensing electrode and the component measuring electrode are formed, with a first sample inlet configured to guide the sample to the component measuring electrode; and a second intermediate plate disposed on the first intermediate plate, with a second sample inlet having a sample inflow passage longer than the first sample inlet.

The second sample inlet formed in the second intermediate plate may guide the sample to a top portion thereof corresponding to a preset portion of the sample sensing electrode.

The component measuring electrode may include one or more pairs of electrodes and at least one enzyme reacting with the sample is immobilized on each surface of the pair of the electrodes.

An air outlet configured to exhaust internal air as the sample is flowing in may be formed in the third plate, corresponding to a preset portion of the second sample inlet.

Exemplary embodiments of the present disclosure also disclose a sample inlet sensing method of a biosensor comprising a sample sensing electrode and a component measuring electrode, the method including measuring a capacitance generated by applying a power to the sample sensing electrode periodically; and determining inflow of a sample based on the capacitance.

The determining of the sample inflow may determine that the sample flows in, when the measured capacitance is over a preset level or change in the capacitances is beyond a preset range.

The sample inlet sensing method may further include measuring a specific component contained in the sample based on electric change of the component measuring electrode generated by the power applying to the component measuring electrode, when determining that the sample flows in.

According to the exemplary embodiments of the disclosure, the sample inflow may be sensed based on change in the capacitances, not based on the direct reaction with the electrode. Accordingly, the influence of the electric reaction generated by the sample inflow on the sample measurement may be reduced as much as possible and the accuracy of the measurement result may be improved.

It is to be understood that both the foregoing general description and the following detailed description are exemplary and explanatory and are intended to provide further explanation of the disclosed subject matter as claimed.

### BRIEF DESCRIPTION OF THE DRAWINGS

The accompanying drawings, which are included to provide a further understanding of the disclosed subject matter and are incorporated in and constitute a part of this specification, illustrate exemplary embodiments of the disclosed subject matter, and together with the description serve to explain the principles of the disclosed subject matter.

FIG. 1 is a diagram illustrating an electrochemical biosensor shown in the cited reference 1;

FIG. 2 is a diagram illustrating the electrochemical biosensor and a measuring instrument shown in FIG. 1;

FIG. 3 is a diagram illustrating the biosensor shown in FIG. 1;

FIGS. 4 and 5 are diagrams illustrating a structure of a biosensor according to exemplary embodiments of the disclosure;

FIGS. 6, 7 and 8 are diagrams illustrating a cross section of a multilayer formed in a biosensor according to exemplary embodiments of the disclosure;

FIG. 9 is a diagram illustrating an equivalent circuit in case a power is applied to a biosensor according to exemplary embodiments of the disclosure;

FIG. 10 is a diagram illustrating an integrated circuit unit for controlling a biosensor according to exemplary embodiments of the disclosure; and

FIGS. 11 and 12 are flow charts illustrating a sample inflow sensing method of a biosensor according to exemplary embodiment of the disclosure.

### DETAILED DESCRIPTION OF THE ILLUSTRATED EMBODIMENTS

Exemplary embodiments of the disclosed subject matter are described more fully hereinafter with reference to the accompanying drawings. The disclosed subject matter may, however, be embodied in many different forms and should not be construed as limited to the exemplary embodiments set forth herein. Rather, the exemplary embodiments are provided so that this disclosure is thorough and complete, and will convey the scope of the disclosed subject matter to those skilled in the art. In the drawings, the size and relative sizes of layers and regions may be exaggerated for clarity. Like reference numerals in the drawings denote like elements.

It will be understood that when an element or layer is referred to as being “on”, “connected to”, or “coupled to” another element or layer, it can be directly on, connected, or coupled to the other element or layer or intervening elements or layers may be present. In contrast, when an element is referred to as being “directly on”, “directly connected to”, or “directly coupled to” another element or layer, there are no intervening elements or layers present. As used herein, the term “and/or” includes any and all combinations of one or more of the associated listed items. It may also be understood that for the purposes of this disclosure, “at least one of X, Y, and Z” can be construed as X only, Y only, Z only, or any combination of two or more items X, Y, and Z (e.g., XYZ, XYY, YZ, ZZ).

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another region, layer or section. Thus, a first element, component, region, layer, or section discussed below could be termed a second element, component, region, layer, or section without departing from the teachings of the present disclosure.

The terminology used herein is for the purpose of describing exemplary embodiments only and is not intended to be limiting of the disclosed subject matter. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the disclosed subject matter are described herein with reference to cross-section illustrations that are schematic illustrations of idealized embodiments (and intermediate structures) of the disclosed subject matter. As such, variations from the shapes of the illustrations as a result, for example, of manufacturing techniques and/or tolerances, are to be expected. Thus, exemplary embodiments of the disclosed subject matter should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this disclosed subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the disclosed subject matter will be described in detail with reference to the accompanying drawings.

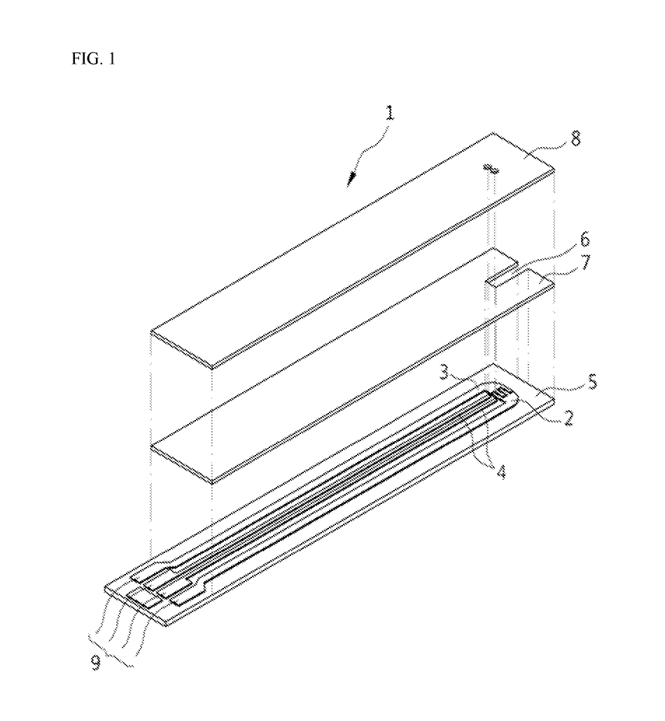

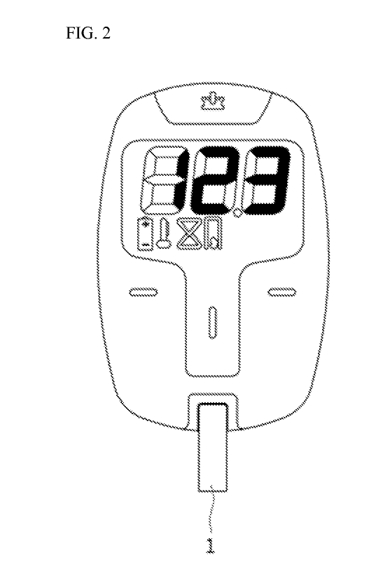

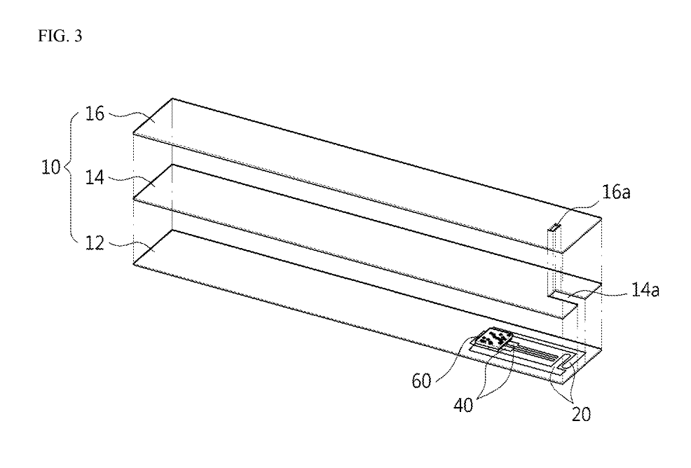

FIG. 3 is a diagram illustrating the biosensor shown in FIG. 1.

Referring to FIG. 3, three plates 10 (specifically, a first plate 12, a second plate 14 and a third plate 16) are arranged in a common housing in the biosensor.

In the first plate 12 may be formed an electrode unit (20 and 40) for measuring a specific component in a sample (e.g., glucose in blood) and an integrated circuit unit 60 for controlling the electrode unit. The electrode unit of the biosensor may include a component measuring electrode 20 for measuring a specific component of a sample and a sample recognizing electrode 40 for sensing inflow of a sample.

The component measuring electrode 20 may include a pair of electrodes, specifically, a working electrode and a reference electrode. An enzyme immobilization unit (not shown) may be arranged between the working electrode and the reference electrode. At this time, the enzyme immobilization unit may provide at least one enzyme. The sample inflowing to the component measuring electrode 20 reacts with the enzyme arranged between the working electrode and the reference electrode. Such reaction may generate electrochemical change and such electrochemical change may be sent to the integrated circuit unit for control 60 as information referring to the amount of the specific component contained in the sample. In addition, electrical characteristics of the sample are measured by the component measuring electrode 20 and it is the most sensitive method for measuring change in electrical characteristics of the sample to fix the enzyme to a surface of the component measuring electrode 20. For that, the enzyme provided to the enzyme immobilization unit may be immobilized in the surface of the component measuring electrode 20.

The sample sensing electrode 40 includes a pair of neighboring electrodes arranged adjacent to the component measuring electrode 20. The sample sensing electrode 40 may provide information about whether a sample is inflowing and whether a sufficient amount of a sample is inflowing. Such information is provided to the integrated circuit unit 60 for controlling.

A drive mode of the integrated circuit unit 60 for controlling may be determined by an electrical signal of the sample sensing electrode based on inflow of a sample or inflow of a sample in sufficient quantities. When sensing the inflow of the sample, using the sample sensing electrode 40, the integrated circuit unit 60 for controlling may measure change in voltages or electric currents of the component measuring electrode 20 so as to measure the quantity of the specific component contained in the sample.

The second plate 14 may be disposed on a top surface of the first plate 12 and a sample inlet 14a may be formed in the second plate 14 to guide the sample to the component measuring electrode 20 and the sample sensing electrode 40 sequentially. An air outlet 16a may be formed in the third plate 16 to exhaust the air inside the housing of the biosensor as the sample is inflowing.

As mentioned above, a second plate 14 provided in a conventional biosensor has a single layer and a passage of the sample to the sample sensing electrode 40 through the component measuring electrode 20 is formed in the second plate 14 by the sample inlet 14a.

When the sample reaches the sample sensing electrode 40 along the sample inflow passage formed by the sample inlet 14a of the second plate 14, it may be recognized from electrical change of the sample sensing electrode 40 that the sample is inflowing or the sufficient sample is inflowing.

However, in the structure that the sample is directly inflowing to the sample sensing electrode 40, electric explosion could be generated by the inflow of the sample to the sample sensing electrode and such electric explosion could affect the component measuring electrode 20, to be a cause of errors in measured component values.

Accordingly, this embodiment propose a structure that the sample is not directly inflowing to the sample sensing electrode 40 and a technology for sensing inflow of the sample based on change in capacitances of the sample sensing electrode 40.

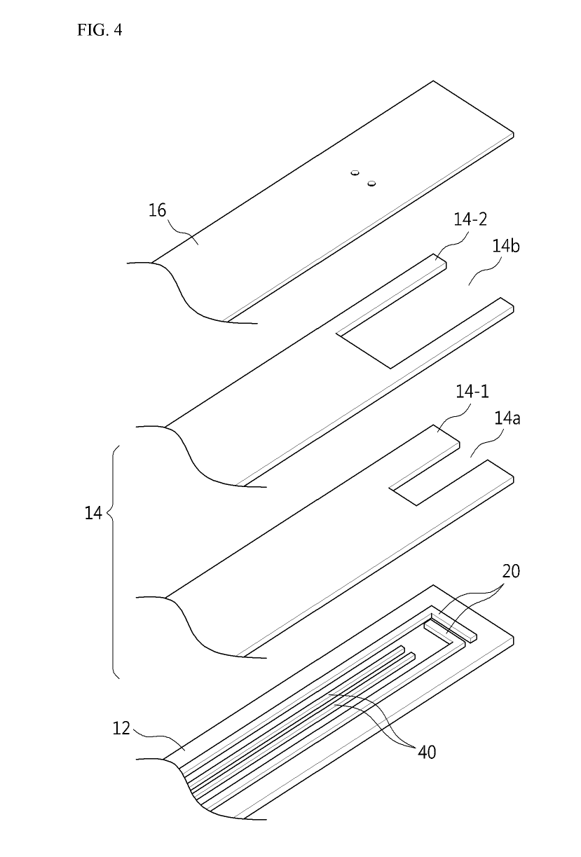

FIG. 4 is a diagram illustrating a biosensor having a structure for sensing sample inflow, using the capacitance.

Referring to FIG. 4, in a housing of a biosensor according to this embodiment may be provided a first plate 12 having an electrode unit 20 and 40 and an integrated circuit unit for controlling (not shown in FIG. 4) formed thereon, a second plate 14 having a sample inflow passage formed therein and a third plate 16 having an air outlet 16a formed therein.

The composition and arrangement structure of the electrode unit 20 and 40 formed on the first plate 12 are the same as those of the electrode unit provided in the biosensor described, referring to FIG. 3.

In this embodiment, a new structure of a biosensor is proposed that sample inflow can be sensed, even without inflowing a sample to a sample sensing electrode directly.

For that, the biosensor shown in FIG. 4 according to the present disclosure may include a second plate 14 which consists of a first intermediate plate 14-1 and a second intermediate plate 14-2 for providing a sample inflow passages having a different length.

The first intermediate plate 14-1 is disposed to a first plate 12 on which a composition measuring electrode 20 and a sample sensing electrode 40 are formed. A first sample inlet 14a may be formed in the first intermediate plate 14-1 to guide a sample toward the composition measuring electrode 20. At this time, the first sample inlet 14a may provide a sample inflow passage having a predetermined length long enough for an inflowing sample to reach a position where an enzyme of the composition measuring electrode 20 is immobilized. Especially, the first sample inlet 14a formed in the first intermediate plate 14-1 may provide a sample inflow passage having a limited length long enough for the sample not to flow in the sample sensing electrode 40.

The second intermediate plate 14-2 may be disposed on the first intermediate plate 14-1 and a second sample inlet 14b for providing an extended sample inflow passage may be formed in the second intermediate plate 14-2. In the exemplary embodiments of the disclosure, the second sample inlet 14b may provide a sample inflow passage longer than the first sample inlet 14a and the sample inflow passage may be long enough for the sample flowing in to reach a position corresponding to a predetermined portion of the sample sensing electrode 40 from between the first intermediate plate 14-1 and the third plate 16.

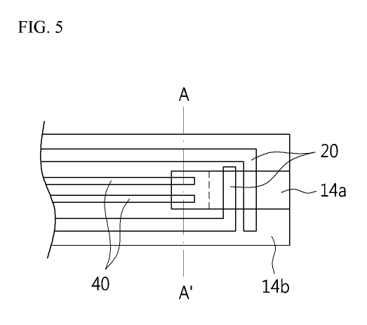

Referring to FIG. 5, the biosensor according to the exemplary embodiments of the disclosure may provide a sample inflow passage structured for the sample to reach only the enzyme of the component measuring electrode 20 directly, not the sample sensing electrode 40, by the first sample inlet 14a and another sample inflow passage structured for the sample flowing between the first intermediate plate 14-1 and the third plate 16 to reach a top portion of the sample sensing electrode 40 by the second sample inlet 14b.

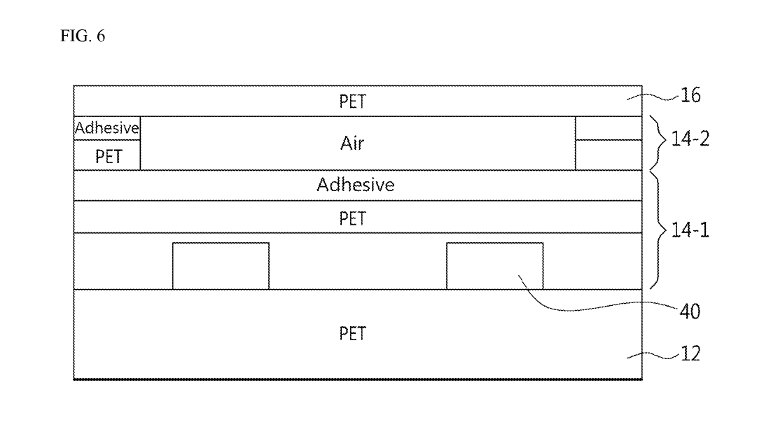

FIGS. 6, 7 and 8 are diagrams illustrating a cross section of a multilayer, in other words, a cross section of A-A′ shown in FIG. 5 formed in a biosensor according to exemplary embodiments of the disclosure. The component measuring electrode is omitted in FIGS. 6 to 8.

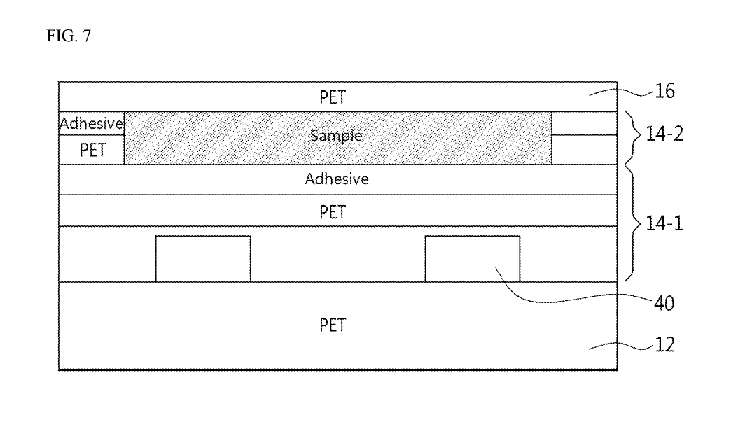

In the cross section of A-A′ shown in FIG. 5, the first intermediate plate 14-1 and the second intermediate plate 14-2 are formed on the first plate 12 sequentially. The third plate 16 is formed on the second plate 14 formed of the first intermediate plate 14-1 and the second intermediate plate 14-2. The sample inflow space formed by the second sample inlet 14b of the second intermediate plate 14-2 is spaced apart from a top of the sample sensing electrode 40 by the first intermediate plate 14-1. The sample inflow space formed by the second sample inlet 14b is filled with air and filled with the sample as shown in FIG. 7, once the sample flows in.

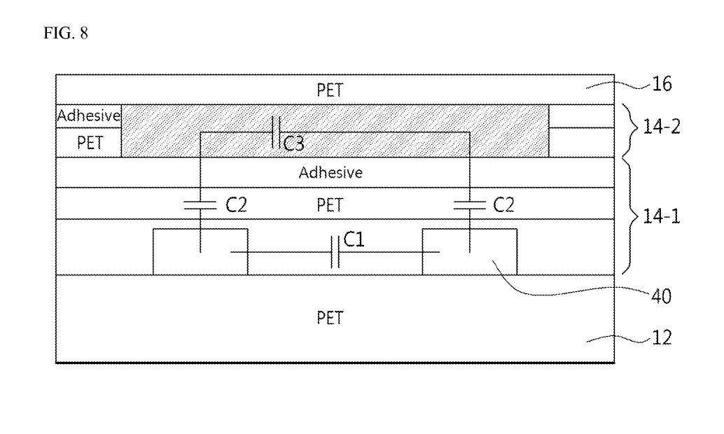

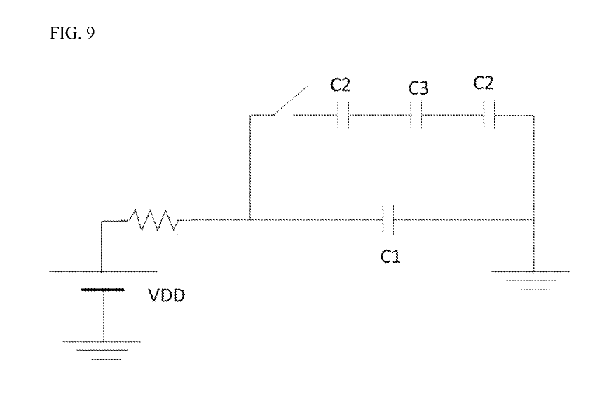

In the biosensor having the structure mentioned above, capacitances C1, C2, C3 and C4 are generated by a potential difference between the pair of the electrodes composing the sample sensing electrode 40 and a dielectric substance (e.g., the sample inflow space) formed between the plates disposed sequentially, as shown in FIG. 8. FIG. 9 shows an equivalent circuit when the power is applied to the biosensor shown in FIGS. 4 to 8.

As a permittivity of the air is different from a permittivity of the sample, the capacitance generated in the sample sensing electrode 40 is differentiated based on the material flowing in the sample inflow space. Such change in the capacitances is used in sensing whether the sample is flowing in.

To sense the inflow of the sample, a switch for applying the power to the sample sensing electrode 40 is periodically switched on and off. Referring to FIG. 9, it is measured how fast an electric charge is recharged, once the power is applied to the sample sensing electrode 40 by the switch switched on, such that a RC constant can be calculated. The capacitance may be calculated based on the RC constant. The calculated capacitance is dependent on C3 change generated by the substance flowing in the sample inflow space and the sample inflow may be sensed based on the change of the C3. For example, the biosensor according the exemplary embodiments of the disclosure may check the capacitances generated in the sample sensing electrode 40. When the measured capacitance is over a preset level or beyond a preset range, the biosensor may recognize that the sample flows in or that a sufficient sample flows in.

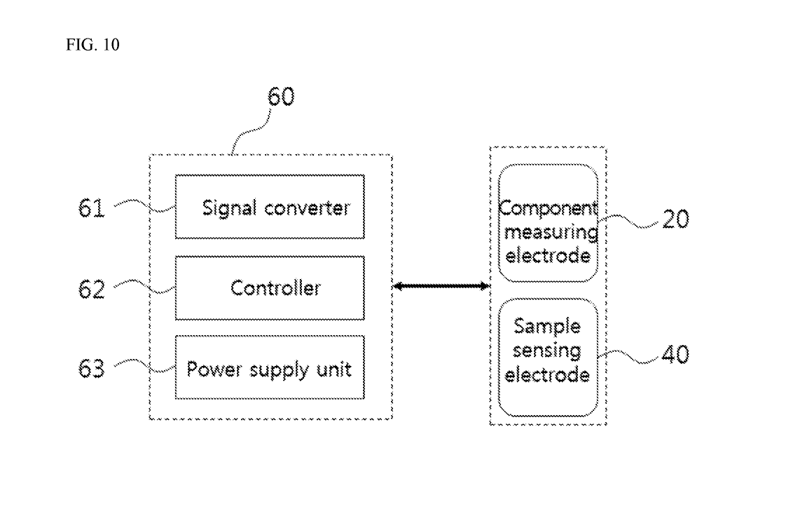

The integrated circuit unit 60 for controlling may include a signal converter 61, a controller 62 and a power supply unit 63, as shown in FIG. 10.

The signal converter 61 may convert electric signals sensed by the component measuring electrode 20 and the sample sensing electrode 40 into a proper signal which can be easily processed by the controller 62. At this time, the signal converter 61 may include a voltage-current converter for converting electric currents into voltages or vice versa. The signal converter may include an AD converter for converting an analog signal into a digital signal, such that an analog signal sensed by the component measuring electrode 20 may be converted into a digital signal by the AD converter. The signal converter 61 may include an amplifier for amplifying a weak sensed signal, when the sensed signal is weak. The signal converter 61 may include a capacitance measuring circuit for measuring the capacitance formed by the sample sensing electrode 40 such that the capacitance measured by the capacitance measuring circuit may be converted into a proper signal which can be processed by the controller 62 easily.

The power supply unit 63 may control the power supply to the component measuring electrode 20 and the sample sensing electrode 40 under the control of the controller 62. At this time, the power supply unit 63 may be provided with the power needed to drive the biosensor by an exclusive measuring instrument or generated by the mountable battery. The power supply unit 63 may be a passive type provided with the power by an exclusive measuring instrument and an active type having a mountable battery to supply the power.

The controller 62 may process information about the sample inflow, using the capacitance measured by the capacitance measuring circuit and information about a specific component of the sample based on the electric reaction of the component measuring electrode 20. The controller 62 may recognize whether the sample flows in or a sufficient quantity of a sample flows in, using change in the capacitances. Also, the controller 62 may control operations of the biosensor based on the result of the recognition. When recognizing that the sample is not flowing in or the sufficient quantity of the sample is not flowing in, the controller 62 may reduce the power consumption in a dormant state. When recognizing that the sample is flowing in or the sufficient quantity of the sample is flowing in, the controller 62 enters into an activated state that consumes relatively much power.

The controller 62 applies the power to the sample sensing electrode 40 in the dormant state periodically. The controller 62 checks change in capacitances sensed by the sample sensing electrode 40, once the power is applied. When the capacitance is over a preset level or change in the capacitances is beyond the preset range, the controller 62 may recognize that the sample is flowing in or the sufficient quantity of the sample is flowing in. when recognizing that the sample is flowing in or that the sufficient quantity of the sample is flowing in, the controller 62 enters an activated state and controls the power supplied to the component measuring electrode 20. Also, the controller 62 may measure the quantity of the specific component contained in the sample by measuring change in the voltages or currents of the component measuring electrode 20.

Accordingly, the controller 62 may sense the sample inflow, using the capacitance change according to the sample sensing electrode 40 and the dielectric substance formed in the sample sensing electrode 40 and adjacent to the sample sensing electrode 40, not using the electric reaction generated by the direct contact of the sample with the sample sensing electrode 40.

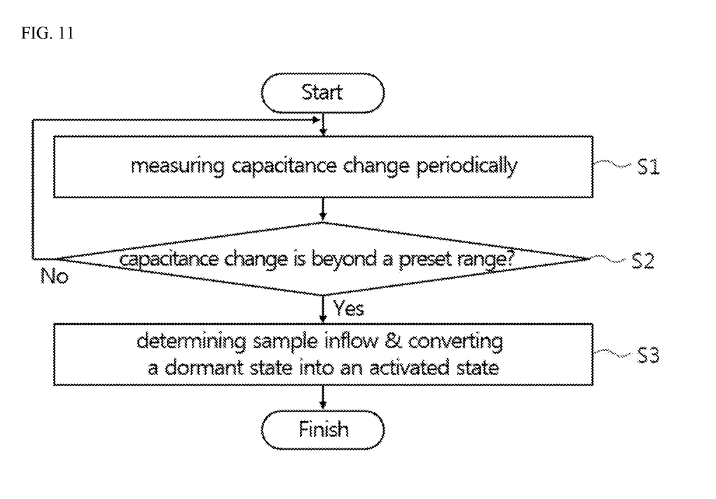

FIG. 11 is a flow chart illustrating a sample inflow sensing method of a biosensor according to exemplary embodiments of the disclosure. Steps of the sample inflow sensing method according to the exemplary embodiments of the disclosure may be performed by the biosensor described in FIGS. 4 to 10 (specifically, the integrated circuit unit for controlling).

In a step of S1, the biosensor applies the power to the sample sensing electrode periodically, to sense the sample inflow while maintaining the dormant state. The biosensor measures a capacitance between both electrodes of the sample sensing electrode based on the power applying.

In a step of S2, the biosensor monitoring the capacitances measured in the step (S1) determines whether the measured capacitance is over a preset level or change in the capacitances is beyond a preset range.

In a step of S3, the biosensor determines that the sample flows in or the sufficient quantity of the sample flows in, once the capacitance measured in the step (S1) is over the preset level or the capacitance change is beyond the preset range based on the result of the determination gained in the step (S2). At this time, when determining that the sample flows in or the sufficient quantity of the sample flows in, the biosensor may enter into the activated state supplying the power to the component measuring electrode and measure a specific component contained in the sample based on the electric change of the component measuring electrode.

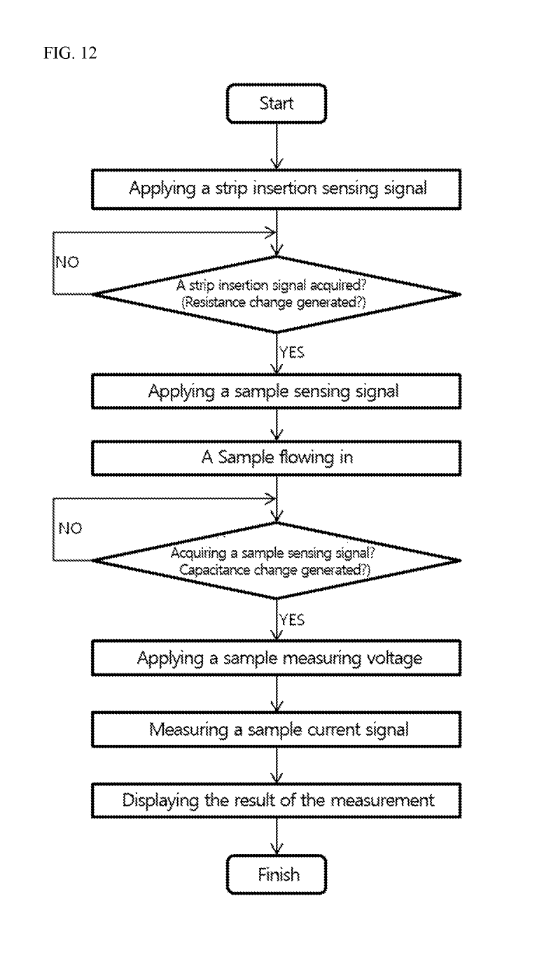

FIG. 12 is a diagram specifically illustrating the method shown in FIG. 11.

Referring to FIG. 12, the biosensor applies a strip insertion recognizing signal in response to a biosensor strip inserted therein. When the strip insertion recognition signal is acquired, a sample recognizing signal for recognizing the sample is applied. After that, the sample flows in and it is determined whether change in capacitances is generated by the inflow of the sample, to recognize the sample. Once the sample inflow is recognized, a measuring voltage is applied and the result of the measurement is displayed.

The sample inflow sensing method of the biosensor may include shortened operations or additional operations based on the specific description mentioned, referring to FIGS. 4 to 10. Two or more operations may be combined or the order or position of the operations may be changed.

The methods according to the exemplary embodiments of the disclosure may be realized into program instructions which can be implemented by various types of computer systems and stored in computer readable medium.

According to the embodiments of the disclosure, the sample inflow may be sensed based on change in the capacitances not based on the direct reaction with the electrode, such that the influence of the electric reaction generated by the sample inflow on the sample measuring may be reduced as much as possible and that the accuracy of the measuring result may be improved.

The device mentioned above described hereinabove may be executed in any suitable device realized by hardware components, software components, and/or a combination of hardware and software components. For instance, the device and components may be realized by using one or more common computers or special purpose computers, which may include a processor, a controller, an Arithmetic Logic Unit (ALU), a digital signal processor, a microcomputer, a Field Programmable Array (FPA), a Programmable Logic Unit (PLU), a microprocessor. The device and components may implement an instruction and respond to the instruction. A processor may execute an operating system (OS) and one or more software applications running on the OS. The processor may store, process, and create data in response to the implementation of software. To make the embodiments of the disclosure understood easily, one processor may be used. It is obvious to the people skilled in the art that the processor includes a plurality of processing elements and/or a processing element having a plurality of types. For instance, the processing device may include a plurality of processors or one processor and one controller. The processing device may have a processing configuration (e.g., a parallel processor).

The software may include a computer program, a code, an algorithm, an instruction, and any combination thereof. The software may include a mechanical language code made by a compiler and a high level language code implementable by a computer, using an interpreter, and the like. The software and/or data may be permanently or temporarily embodied in a preset type of a machine, a component, a physical device, virtual equipment, a computer storage medium or device or a transmitted signal. The software may be dispersed on a computer system or through a network. The software and data may be stored or implemented in one or more computer readable recording medium.

The method according to the embodiments may be realized as program instruction implemented by various computer means and recorded in a computer readable medium. The computer readable medium may include a program command, a data file, a data structure or combination of them. The program command recorded in the medium may be configured for exemplary embodiments of the disclosure. Examples of computer readable medium include magnetic medium such as a hard disk, a floppy disk, optical medium such as CD-ROM and DVD, magneto-optical medium such as a floptical disk, and a hardware device such as ROM, RAM, and a flash memory. The hardware device may be configured to execute one or more software modules to implement the exemplary embodiments. The software may include a computer program, a code, an algorithm, an instruction, and any combination thereof. The software may include a mechanical language code made by a compiler and a high level language code implementable by a computer, using an interpreter, and the like. The software may be dispersed on a computer system or through a network. The software and data may be stored or implemented in one or more computer readable recording medium.

It will be apparent to those skilled in the art that various modifications and variations can be made in the present disclosure without departing from the spirit or scope of the disclosed subject matter. Thus, it is intended that the present disclosure cover the modifications and variations of the disclosed subject matter provided they come within the scope of the appended claims and their equivalents.

What is claimed is:

1. A biosensor comprising:
a sample sensing electrode configured to sense inflow of a sample;
a component measuring electrode configured to measure a specific component contained in the sample; and
an integrated circuit unit for controlling configured to apply a power to the sample sensing electrode periodically and to determine the inflow of the sample based on a capacitance generated by the power applied to the sample sensing electrode.

2. The biosensor of claim 1, wherein the integrated circuit unit for controlling measures capacitances generated by the power applied to the sample sensing electrode and determines that the sample flows in, when the measured capacitance is over a preset level or change in the capacitances is beyond a preset range.

3. The biosensor of claim 1, wherein the integrated circuit unit for controlling converts a dormant state applying the power only to the sample sensing electrode, not to the component measuring electrode, into an activated state applying the power to the component measuring electrode once determining that the sample flows in.

4. The biosensor of claim 1, wherein the integrated circuit unit for controlling measures a specific component contained in the sample based on electric change of the component measuring electrode generated by the reaction between an enzyme immobilized on the component measuring electrode and the sample.

5. A biosensor comprising:
a first plate;
a sample sensing electrode formed on the first plate to sense inflow of a sample;
a component measuring electrode formed on the first plate to measure a specific component contained in the sample;
a second plate disposed on the first plate where the sample sensing electrode and the component measuring electrode are formed; and
a third plate disposed on the second plate,
wherein a sample inlet is formed in the second plate to guide the flowing sample along a structure configured for the flowing sample to reach the component measuring electrode, not the sample sensing electrode.

6. The biosensor of claim 5, wherein the sample sensing electrode is arranged adjacent to the component measuring electrode, spaced apart a predetermined distance in a direction in which the sample is flowing in.

7. The biosensor of claim 5, wherein the sample sensing electrode is arranged adjacent to the component measuring electrode, spaced apart a predetermined distance in a direction in which the sample is flowing in, and
the second plate comprises;
a first intermediate plate disposed on the first plate on which the sample sensing electrode and the component measuring electrode are formed, with a first sample inlet configured to guide the sample to the component measuring electrode; and
a second intermediate plate disposed on the first intermediate plate, with a second sample inlet having a sample inflow passage longer than the first sample inlet.

8. The biosensor of claim 7, wherein the second sample inlet formed in the second intermediate plate guides the sample to a top portion thereof corresponding to a preset portion of the sample sensing electrode.

9. The biosensor of claim 5, wherein the component measuring electrode comprises one or more pairs of electrodes and at least one enzyme reacting with the sample is immobilized on each surface of the pair of the electrodes.

10. The biosensor of claim 5, wherein an air outlet configured to exhaust internal air as the sample is flowing in is formed in the third plate, corresponding to a preset portion of the second sample inlet.

11. A sample inlet sensing method of a biosensor comprising a sample sensing electrode and a component measuring electrode, the method comprising:
measuring a capacitance generated by applying a power to the sample sensing electrode periodically; and
determining inflow of a sample based on the capacitance.

12. The sample inlet sensing method of claim 11, wherein the determining of the sample inflow determines that the sample flows in, when the measured capacitance is over a preset level or change in the capacitances is beyond a preset range.

13. The sample inlet sensing method of claim 11, further comprising:
measuring a specific component contained in the sample based on electric change of the component measuring electrode generated by the power applying to the component measuring electrode, when determining that the sample flows in.
